(19) United States
(12) Patent Application Publication
(10) Pub. No.: US 2020/0292002 A1
(43) Pub. Date: Sep. 17, 2020

(54) SEALING DEVICE AND ROLLING BEARING DEVICE

(71) Applicant: JTEKT CORPORATION, Osaka (JP)

(72) Inventors: Takafumi UEMOTO, Kashiwara-shi (JP); Yuya YAMAMOTO, Osaka-shi (JP); Takuya TODA, Kashiwara-shi (JP); Suguru NAKAJIMA, Kashiwara-shi (JP)

(73) Assignee: JTEKT CORPORATION, Osaka (JP)

(21) Appl. No.: 16/804,122

(22) Filed: Feb. 28, 2020

(30) Foreign Application Priority Data
Mar. 13, 2019 (JP) 2019-045604

(51) Int. Cl. F16C 33/80; F16C 33/78

(52) U.S. Cl. CPC F16C 33/805; B60B 27/0073; F16C 33/7816

(57) ABSTRACT

A sealing device includes a seal member and a slinger. A labyrinth clearance is provided in a part of a clearance between the seal member and the slinger. The labyrinth clearance includes an outer clearance that opens toward the outside, a central clearance which is continuous with the outer clearance and of which a flow passage direction intersects with that of the outer clearance, and an inner clearance which is continuous with the central clearance and of which a flow passage direction intersects with that of the central clearance. An opening of the outer clearance has a dimension of 0.3 mm or larger and 0.7 mm or smaller. The central clearance has a length of 3 mm or longer in the flow passage direction. The inner clearance has a clearance dimension of 0.3 mm or larger and 1.0 mm or smaller.

### CROSS-REFERENCE TO RELATED APPLICATION

This application claims priority to Japanese Patent Application No. 2019-045604 filed on Mar. 13, 2019, incorporated herein by reference in its entirety.

### BACKGROUND

### 1. Technical Field

The disclosure relates to a sealing device and a rolling bearing device having a sealing device.

### 2. Description of Related Art

Vehicles, such as automobiles, employ a wheel bearing device (hub unit) to support a wheel. The wheel bearing device includes an outer ring member (also called an outer member) mounted on a vehicle body, an inner shaft member (also called an inner member) on which the wheel is mounted, and a plurality of rolling elements (balls) disposed between the outer ring member and the inner shaft member. It is necessary to prevent water from entering a bearing inner space of the wheel bearing device where the rolling elements are provided. In the case of a wheel bearing device, such water contains mud. To prevent entry of water, a sealing device is provided between the outer ring member and the inner shaft member. Published Japanese Translation of PCT Application No. 2013-534301 (JP-A-2013-534301) discloses a sealing device that is provided on a vehicle outer side (outboard side) of a wheel bearing device.

### SUMMARY

As shown in FIG. 5, the sealing device described in JP-A-2013-534301 has an annular seal member 91 mounted on an outer circumferential surface 90b of an outer ring member 90, and an annular slinger 94 mounted on an inner shaft member 92. The seal member 91 has a seal lip 98, and the seal lip 98 is in contact with a part of the slinger 94. A labyrinth clearance 96 is formed between a part 91a of the seal member 91 and a part 94a of the slinger 94.

in rainy regions, roads are sometimes flooded. When a wheel becomes submerged in water, at least a part of the sealing device in a circumferential direction (a part thereof on a road surface side) may sink under water. Moreover, when the vehicle is in a stationary state, water may pass through the labyrinth clearance 96 and enter inside the sealing device under the influence of (the pressure of) the water flooding the road. The water having entered inside contains mud. If the seal lip 98 comes into sliding contact with the slinger 94 through the mud, the seal lip 98 may wear faster, resulting in degradation of sealing performance. Then, water may enter a bearing inner space 105 between the outer ring member 90 and the inner shaft member 92.

Therefore, the present disclosure provides a sealing device and a rolling bearing device that can restrain water from entering inside the sealing device and easily discharge water having entered inside the sealing device, if any, to the outside.

A sealing device according to a first aspect of this disclosure includes an annular seal member mounted on an outer member, and an annular slinger mounted on an inner member that rotates relatively to the outer member. A labyrinth clearance is provided in a part of a clearance between the annular seal member and the annular slinger. The labyrinth clearance includes an outer clearance that opens toward the outside, a central clearance which is continuous with the outer clearance and of which a flow passage direction intersects with a flow passage direction of the outer clearance, and an inner clearance which is continuous with the central clearance and of which a. flow passage direction intersects with the flow passage direction of the central clearance. An opening of the outer clearance has a dimension of 0.3 mm or larger and 0.7 mm or smaller. The central clearance has a length of 3 mm or longer in the flow passage direction. The inner clearance has a clearance dimension of 0.3 mm or larger and 1.0 mm or smaller.

In this sealing device, the labyrinth clearance makes it less likely that external water enters inside the sealing device. The function of restricting entry of water by the labyrinth clearance is enhanced in a state where the outer member and the inner member are rotating relatively to each other. On the other hand, when the relative rotation stops and, moreover, the vehicle is in an environment where at least a part of the sealing device in the circumferential direction is under water, water may pass through the labyrinth clearance and enter inside the sealing device under the influence of a water pressure from the outside. When the relative rotation starts, water having entered inside is delivered toward the outside by a centrifugal force, but the water is difficult to discharge due to the influence of the water pressure from the outside. However, a water film is formed in the outer clearance, the central clearance, and the inner clearance of the labyrinth clearance owing to the dimensions of these parts set as described above, and this water film can exert a force against the water pressure from the outside. When the relative rotation starts in this state, a centrifugal force acts also on water inside the labyrinth clearance, which helps discharge the water inside to the outside. For this reason, water can be restrained from entering inside the sealing device, and water having entered inside the sealing device can be easily discharged to the outside. The “flow passage direction” means a direction in which water flows when passing through the labyrinth clearance.

In the above aspect, the central clearance may have a clearance dimension of 0.3 mm or larger and 1.0 mm or smaller. In this case, the function of restricting entry of water as described above can be further enhanced and a water film formed in the central clearance is likely to be maintained.

In the above aspect, the inner clearance may have a length of 2.5 mm or longer in the flow passage direction. In this case, the function of restricting entry of water as described above can be further enhanced and a water film formed in the central clearance is likely to be maintained.

A rolling bearing device according to a second aspect of this disclosure includes: an outer member; an inner member; a plurality of rolling elements provided between the outer member and the inner member; and a sealing device that prevents foreign objects from entering a bearing inner space which is between the outer member and the inner member and in which the rolling elements are provided. The sealing device is the sealing device according to the first aspect. This rolling bearing device can restrain water from entering inside the sealing device and easily discharge water having entered inside the sealing device to the outside.

The present disclosure having these aspects can restrain water from entering inside the sealing device and easily discharge water having entered inside the sealing device to the outside.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a sectional view showing an example of a rolling bearing device;

FIG. 2 is a sectional view showing an outer-side sealing device and surroundings thereof;

FIG. 3 is a sectional view of the outer-side sealing device;

FIG. 4 is a sectional view showing a labyrinth clearance and surroundings thereof;

FIG. 5 is a sectional view showing a sealing device of a related art,

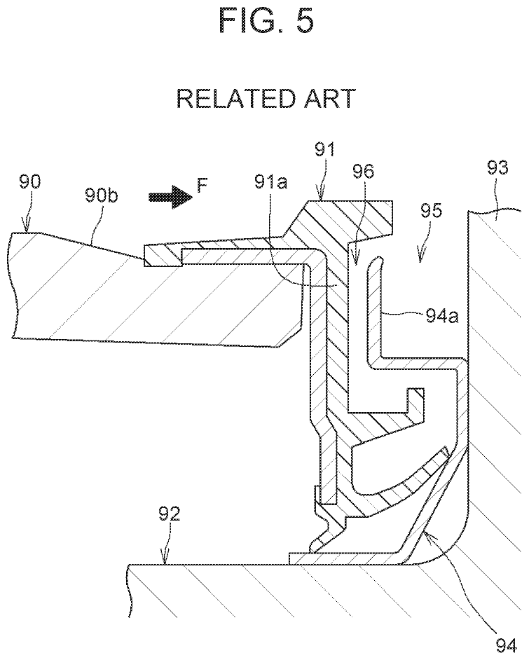

### DETAILED DESCRIPTION OF EMBODIMENTS

Rolling Bearing Device

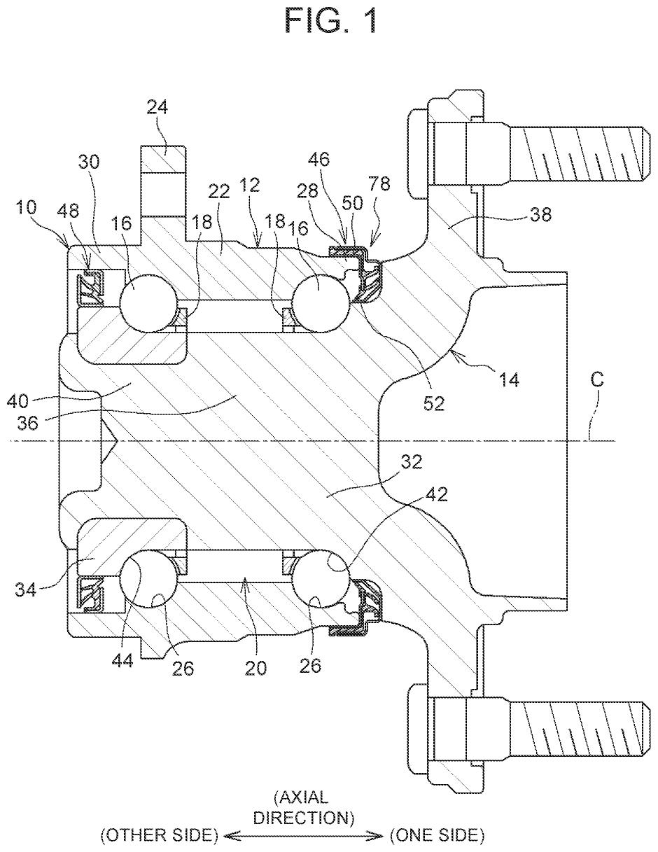

FIG. 1 is a sectional view showing an example of a rolling bearing device. A rolling bearing device 10 (hereinafter also referred to as a “bearing device 10”) shown in FIG. 1 is mounted on a suspension (also called a “knuckle”) provided in a vehicle body of a vehicle (automobile) and rotatably supports a wheel. The bearing device 10 is also called a hub unit. In a state where the bearing device 10 is mounted on the vehicle body (suspension), the right side in FIG. 1 is a wheel side and called a vehicle outer side. The left side in FIG. 1 is a vehicle body center side and called a vehicle inner side.

The bearing device 10 includes an outer ring member (also called an outer member) 12, an inner shaft member (also called an inner member) 14, and a plurality of rolling elements 16 provided between the outer ring member 12 and the inner shaft member 14. The rolling elements 16 of this disclosure are balls. In the bearing device 10 of this disclosure, an axial direction is a direction parallel to a centerline C of the bearing device 10 (hereinafter referred to as a “bearing centerline C”). The axial direction of the bearing device 10 and an axial direction of a sealing device 46 to be described later coincide with each other. The axial direction of the bearing device 10 and the axial direction of the sealing device 46 will be each referred to simply as an “axial direction.” A radial direction is a direction orthogonal to the bearing centerline C. The radial direction of the bearing device 10 and a radial direction of the sealing device 46 to be described later coincide with each other. The radial direction of the bearing device 10 and the radial direction of the sealing device 46 will be each referred to simply as a “radial direction.” For the convenience of description, the vehicle outer side and the vehicle inner side will be referred to as “one side in the axial direction” and “the other side in the axial direction,” respectively, in this disclosure.

The outer ring member 12 has an outer ring main body 22 having a cylindrical shape, and a flange 24 extending from the outer ring main body 22 toward a radially outer side. An outer ring raceway surface 26 is formed in an inner circumference of the outer ring main body 22, on each of the one side and the other side in the axial direction. The flange 24 is mounted onto the knuckle (not shown) that is a vehicle body-side member. The bearing device 10 including the outer ring member 12 is thereby fixed to the vehicle body. Each of an end 28 of the outer ring member 12 on the one side in the axial direction and an end 30 thereof on the other side in the axial direction has a cylindrical shape.

The inner shaft member 14 has a shaft-shaped hub shaft 32 (inner shaft) and an inner ring 34 fixed on the other side of the hub shaft 32 in the axial direction. The hub shaft 32 has a shaft main body 36 located radially inward of the outer ring member 12, and a flange 38 provided on the one side of the shaft main body 36 in the axial direction. The shaft main body 36 is a part elongated in the axial direction. The flange 38 is a part extending from the one side of the shaft main body 36 in the axial direction toward the radially outer side. While this is not shown, a brake rotor and a wheel are mounted onto the flange 38. The inner ring 34 is an annular member, and is fitted and fixed on an outer e of a part 40 of the shaft main body 36 on the other side in the axial direction.

A shaft raceway surface 42 is formed on an outer circumferential side of the shaft main body 36, and an inner ring raceway surface 44 is formed in an outer circumferential surface of the inner ring 34. A plurality of rolling elements 16 is provided between the outer ring raceway surface 26 and the shaft raceway surface 42 on the one side in the axial direction. A plurality of rolling elements 16 is provided between the outer ring raceway surface 26 and the inner ring raceway surface 44 on the other side in the axial direction. The rolling elements 16 are provided in two rows respectively on the one side and the other side in the axial direction. The rolling elements 16 in each row are held by a cage 18. This configuration allows the inner shaft member 14 to rotate around the bearing centerline C relatively to the outer ring member 12.

An annular bearing inner space 20 where the rolling elements 16 are provided is formed between the outer ring member 12 and the inner shaft member 14. To prevent foreign objects such as water from entering the bearing inner space 20 from an outside, the bearing device 10 further includes a pair of sealing devices 46, 48. The sealing device 46 is provided between the end 28 of the outer ring member 12 on the one side in the axial direction and the inner shaft member 14. The other sealing device 48 is provided between the end 30 of the outer ring member 12 on the other side in the axial direction and the inner shaft member 14 (inner ring 34). The sealing device 46 on the one side in the axial direction is called an outer-side sealing device 46. The sealing device 48 on the other side in the axial direction is called an inner-side sealing device 48,

Outer-Side Sealing Device 46

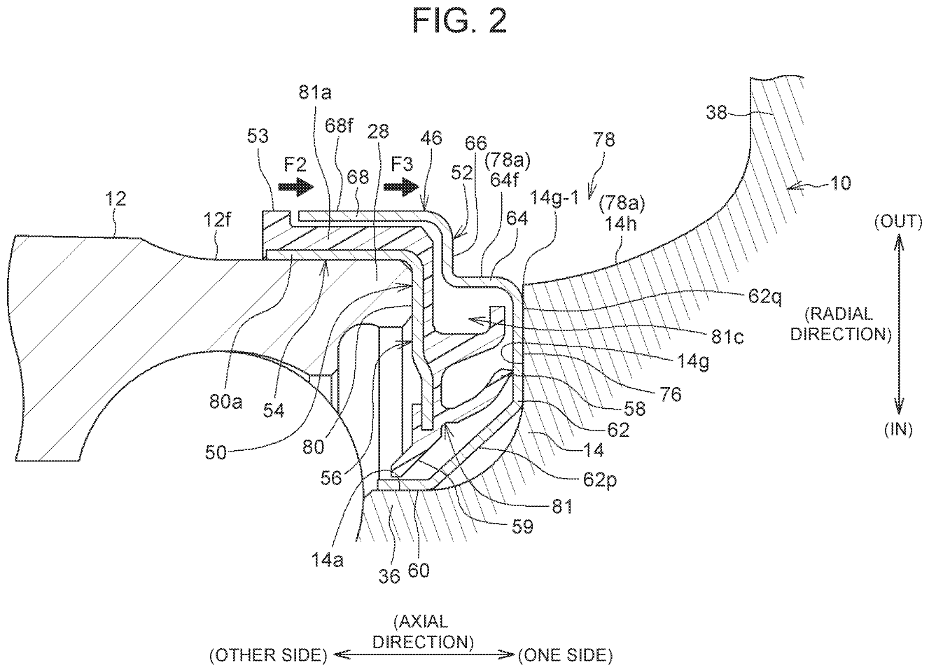

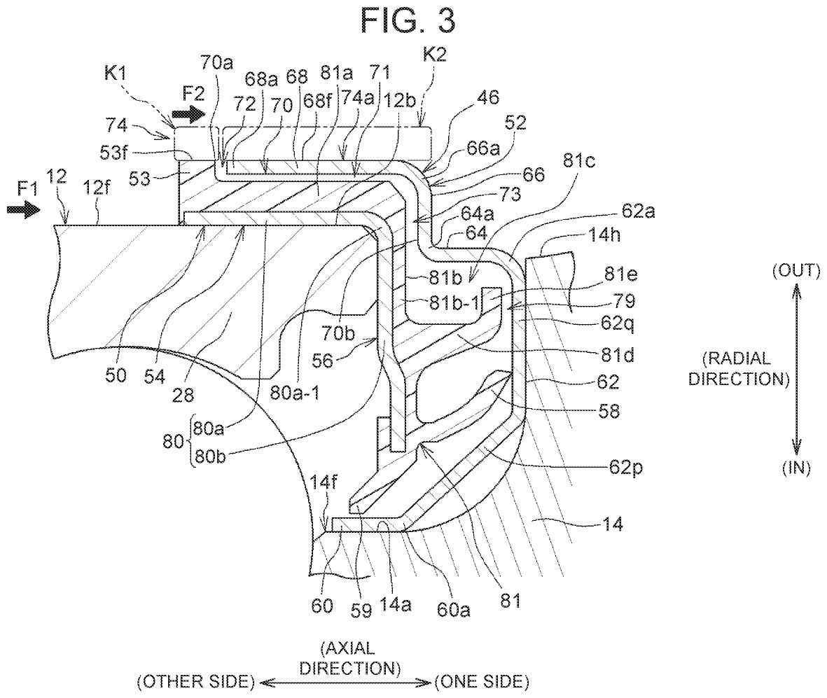

FIG. 2 is a sectional view showing the outer-side sealing device 46 and surroundings thereof. FIG. 3 is a sectional view of the outer-side sealing device 46. The sealing device 46 includes an annular seal member 50 and an annular slinger 52. The seal member 50 is mounted on the outer ring member 12. The slinger 52 is mounted on the inner shaft member 14 and rotates with the inner shaft member 14.

In FIG. 3, the seal member 50 has a metal core (metal ring) 80 and a rubber seal member 81. The seal member 81 is fixed to the core 80 by cure adhesion. The core 80 has a cylindrical part 80a having a cylindrical shape, and an annular part 80b extending from an end 80a-1 of the cylindrical part 80a on the one side in the axial direction toward a radially inner side. The seal member 50 is fixed to the outer ring member 12 as the cylindrical part 80a is fitted on the end 28 of the outer ring member 12 with interference.

The seal member 81 has a cylindrical covering part 81a that covers the cylindrical part 80a, an annular covering part 81b that covers the annular part 80b, seal lips 58, 59 that are provided so as to extend from the annular covering part 81b, and an inner gutter 81c.

The seal lip (axial lip) 58 is provided so as to extend mainly in the axial direction, and is in contact with a part (first radial part 62) of the slinger 52. The seal lip (radial lip) 59 is provided so as to extend mainly in the radial direction. While the seal lip (radial lip) 59 may be in contact with another part (slinger fixing part 60) of the slinger 52, the seal lip 59 of this disclosure is provided close to that part, with a small clearance left therebetween.

The inner gutter 81c is provided so as to be integral with a portion 81b5-1 of the annular covering part 81b. The inner gutter 81c is located radially outward of the seal lip 58. The inner gutter 81c has a cylindrical bottom 81d extending from the annular covering part 81b toward the one side in the axial direction, and an annular side wall 81e extending from an end of the bottom 81d on the one side in the axial direction toward the radially outer side. The inner gutter 81c is formed inside the sealing device 46 by the portion 81b-1 of the covering part 81b, the bottom 81d, and the side wall 81e.

The side wall 81e forms a side wall of the inner gutter 81c on the one side in the axial direction. The portion 81b-1 of the covering part 81b forms a side wall of the inner gutter 81c on the other side in the axial direction. The bottom 81d forms a bottom wall of the inner gutter 81c. The inner gutter 81c is formed as a circumferential groove opening toward the radially outer side. The inner gutter 81c is located radially inward of an inside opening 70b of a labyrinth clearance 70 to be described later. The opening 70b opens toward the radially inner side. Foreign objects such as water that have passed through the labyrinth clearance 70 are caught by the inner gutter 81e. Therefore, foreign objects such as water do not directly reach the contact part between the seal lip 58 and the slinger 52 (first radial part 62).

The seal member 50 further has a large-diameter part 53 having a larger outside diameter than the cylindrical covering part 81a. The large-diameter part 53 is a part continuous with the other side of the covering part 81a in the axial direction and formed by a part of the seal member 81. The large-diameter part 53, together with the covering part 81a, covers the cylindrical part 80a. The outside diameter of the large-diameter part 53 is larger than the outside diameter of a part 12b of an outer circumferential surface 12f of the outer ring member 12 (end 28) on which the seal member 50 is mounted. Thus, when seen in a direction along the outer circumferential surface 12f from the other side toward the one side in the axial direction, the large-diameter part 53 looks like a wall.

The cylindrical seal fixing part 54 is formed by the cylindrical covering part 81a of the seal member 81 and the cylindrical part 80a of the core 80. The seal fixing part 54 is mounted on the part 12b of the outer circumferential surface 12f of the outer ring member 12. The seal main body 56 is formed by the covering part 81b, the seal lips 58, 59, and the inner gutter 81c of the seal member 81, and the annular part 80b of the core 80.

The slinger 52 has a. slinger fixing part 60, a first radial part 62, a first axial part 64, a second radial part 66, and a second axial part 68, in this order from the inner side toward the outer side in the radial direction.

The slinger fixing part 60 is a cylindrical part. The slinger fixing part 60 is mounted on a part 14a of the outer circumferential surface 14f of the inner shaft member 14. The slinger 52 is fixed to the inner shaft member 14 as the slinger fixing part 60 is fitted on the part 14a with interference.

The first radial part 62 has a tapered first portion 62p and an annular second portion 62q. The first portion 62p is a portion that is directed toward the radially outer side while extending from an end 60a of the slinger fixing part 60 on the one side in the axial direction toward the one side in the axial direction. The second portion 62q is a portion that extends from the first portion 62p toward the radially outer side. The seal lip 58 is in contact with the second portion 62q. A clearance 79 is provided between the second portion 62q and the inner gutter 81c. Thus, the first radial part 62 is a part which extends from the end 60a of the slinger fixing part 60 on the one side in the axial direction. toward the radially outer side and with which the seal lip 58 is in contact.

The first axial part 64 is a cylindrical part extending from an end 62a of the first radial part 62 on the radially outer side toward the other side in the axial direction, The first axial part 64 is located at such a position as to cover an area larger than most part of the inner gutter 81e from the radially outer side. The outside diameter of the first axial part 64 and the outside diameter of a stepped surface 14h of the inner shaft member 14 at an end on the other side in the axial direction are set to be (substantially) equal. The stepped surface 14h will be described later.

The second radial part 66 is an annular part extending from an end 64a of the first axial part 64 on the other side in the axial direction toward the radially outer side. The second radial part 66 is located at such a position as to face the covering part 81b in the axial direction across a clearance (third clearance) 73. An end of the clearance 73 on the radially inner side forms the inside opening 70b of the labyrinth clearance 70. An outside opening of the labyrinth clearance 70, opposite from the opening 70b, is denoted by reference sign 70a. The inner gutter 81c is located radially inward of and directly below the clearance 73.

The second axial part 68 is a cylindrical part extending from an end 66a of the second radial part 66 on the radially outer side toward the other side in the axial direction. The second axial part 68 is located at such a position as to face the seal fixing part 54 in the radial direction across a clearance (first clearance) 71. An end 68a of the second axial part 68 on the other side in the axial direction and the large-diameter part 53 of the seal member 50 face each other in the axial direction across a clearance (second clearance) 72. The second clearance 72 opens toward the radially outer side. An upper end of the second clearance 72 forms the outside opening 70a of the labyrinth clearance 70.

In the sealing device 46 of this disclosure, the first clearance 71 and the second clearance 72 communicate with each other, and the first clearance 71 further communicates with the third clearance 73. Thus, the labyrinth clearance 70 includes the first clearance 71, the second clearance 72, and the third clearance 73. The specific dimensions etc. of the labyrinth clearance 70 will be described later.

An outer circumferential surface 53f of the large-diameter part 53 of the seal member 50 and an outer circumferential surface 68f of the second axial part 68 of the slinger 52 are equivalent (substantially equal) in diameter. The meaning of being equivalent in diameter here may include nut only that two diameters are exactly the same but also that two diameters are slightly different from each other. The diameters of the outer circumferential surface 53f of the large-diameter part 53 and the outer circumferential surface 68f of the second axial part 68 may be different from each other within a range taking into account manufacturing errors of each of the seal member 50 and the slinger 52 and assembly dimensional errors upon assembly of these members (due to elastic deformation). The outer circumferential surface 53f of the large-diameter part 53 may be slightly larger in diameter than the outer circumferential surface 68f of the second axial part 68, or vice versa. “Slightly” here means, as a guide, for example, a value smaller than 1% of the diameter of the outer circumferential surface 68f.

Here, when the vehicle travels, water on the road surface is splashed and flows on the outer circumferential side of the bearing device 10 (see FIG. 2). Thus, the outer circumferential side of the outer ring member 12 serves as a flow passage for water to flow through. This water contains mud. An area in the flow passage in which the sealing device 46 is provided will be described. In FIG. 3, a region K1 radially outward of the large-diameter part 53 of the seal member 50 and a region K2 radially outward of the second axial part 68 of the slinger 52 form an outside flow passage 74 located radially outward of the sealing device 46.

The outside flow passage 74 is a continuous flow passage extending in a straight line along the axial direction. This means that in the outside flow passage 74, there is no wall orthogonal to the axial direction that significantly hinders the flow of water. As described above, the outer circumferential surface 53f of the large-diameter part 53 and the outer circumferential surface 68f of the second axial part 68 are equivalent (substantially equal) in diameter. Therefore, the outer circumferential surface 53f of the large-diameter part 53 and the outer circumferential surface 68f of the second axial part 68 are included in a flow passage surface 74a of the continuous outside flow passage 74 extending in a straight line along the axial direction. External water can flow in a straight line along the axial direction, along the flow passage surface 74a including the outer circumferential surface 53f of the large-diameter part 53 and the outer circumferential surface 68f of the second axial part 68.

Outer Gutter Structure 78

As shown in FIG. 2, the bearing device 10 of this disclosure includes an outer gutter structure 78 formed by a part of the inner shaft member 14 and a part of the sealing device 46. The gutter structure 78 is formed as a circumferential groove opening toward the radially outer side. The specific configuration of the gutter structure 78 will be described.

As described above, the inner shaft member 14 has the shaft main body 36 and the flange 38. The shaft main body 36 has the part 14a of the outer circumferential surface of the inner shaft member 14 at which the slinger fixing part 60 is fixed to the inner shaft member 14. The flange 38 is a part extending from the one side of the shaft main body 36 in the axial direction toward the radially outer side. The flange 38 has an annular wall surface 14g extending from the part 14a of the outer circumferential surface of the inner shaft member 14 toward the radially outer side, and the stepped surface 14h extending from an end 14g-1 of the wall surface 14g on the radially outer side toward the one side in the axial direction. The stepped surface 14h is a surface of which the outside diameter increases gradually toward the one side in the axial direction.

The first radial part 62 of the slinger 52 has a contact surface 76 that is in contact with the annular wall surface 14g. In this disclosure, a side surface of the annular second portion 62q on the one side in the axial direction forms the contact surface 76. An outer circumferential surface 64f of the first axial part 64 of the slinger 52 and the stepped surface 14h of the flange 38 form a bottom surface 78a of the common gutter structure 78. Thus, the outer circumferential surface 64f of the first axial part 64 and the stepped surface 14h of the flange 38 are included in the bottom surface 78a of the gutter structure 78. As described above, the outside diameter of the outer circumferential surface 64f of the first axial part 64 and the outside diameter of the stepped surface 14h at the end on the other side in the axial direction are set to be (substantially) equal. As shown in FIG. 2, the outside diameters of the outer circumferential surface 64f and the stepped surface 14h may be exactly the same, but may also he different from each other within the range of the value of the plate thickness of the first axial part 64. Thus, the bottom surface 78a continuous in the axial direction is constituted by the outer circumferential surface 64f of the first axial part 64 and the stepped surface 14h.

The gutter structure 78 can catch external water. In particular, the gutter structure 78 can catch water that has flowed toward the one side in the axial direction along the outer circumferential side of the bearing device 10. Water caught by the gutter structure 78 flows down along the circumferential groove of the gutter structure 78 and falls onto the road surface.

Specific Configuration of Labyrinth Clearance 70

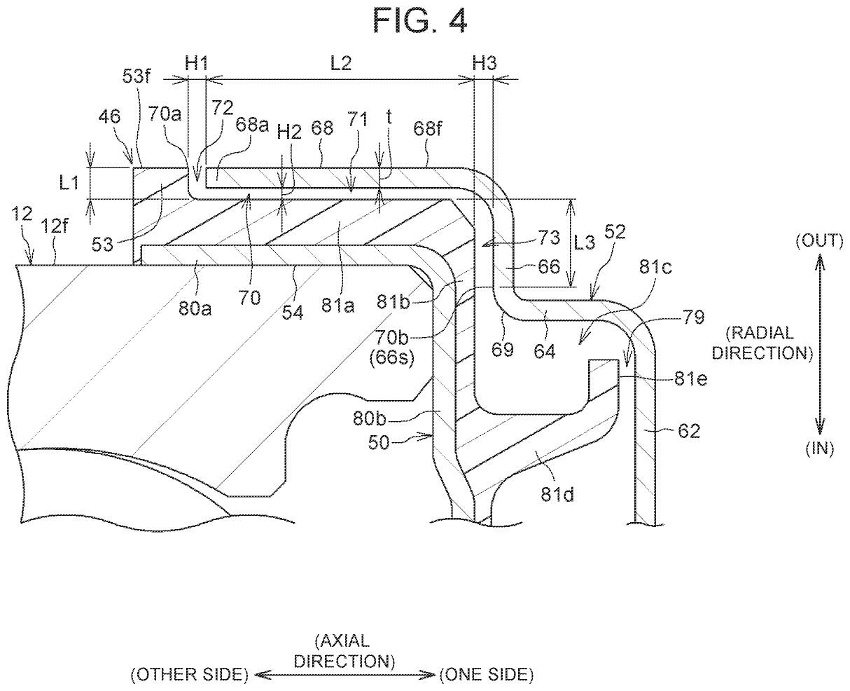

FIG. 4 is a sectional view showing the labyrinth clearance 70 and surroundings thereof. The labyrinth clearance 70 that restricts entry of external water is formed in the sealing device 46, between the seal member 50 and a part of the slinger 52. As described above, the labyrinth clearance 70 includes the first clearance 71, the second clearance 72, and the third clearance 73.

The second clearance 72 opens toward the outside. Hereinafter, the second clearance 72 will be also referred to as an “outer clearance 72.” The third clearance 73 opens toward the inside of the sealing device 46. Hereinafter, the third clearance 73 will also be referred to as an “inner clearance 73.” The first clearance 71 is a clearance located between the outer clearance 72 and the inner clearance 73, and is continuous with each of the outer clearance 72 and the inner clearance 73. Hereinafter, the first clearance 71 will also be referred to as a “central clearance 71.” The opening on the outside of the outer clearance 72 is denoted by reference sign 70a. The opening in the inner clearance 73, on the inside of the sealing device 46 is denoted by reference sign 70b.

The inner clearance 73 is continuous with the central clearance 71, and the flow passage direction of the inner clearance 73 is orthogonal to that of the central clearance 71. The central clearance 71 is continuous with the outer clearance 72, and the flow passage direction of the central clearance 71 is orthogonal to that of the outer clearance 72. The “flow passage direction” means a direction in which water flows when passing through the labyrinth clearance 70. The flow passage direction of the outer clearance 72 should at least have a radial component, and coincides with the radial direction in this disclosure. The flow passage direction of the inner clearance 73 should at least have a radial component, and coincides with the radial direction in this disclosure. The flow passage direction of the central clearance 71 should at least have an axial component, and coincides with the axial direction in this disclosure.

A dimension (in the axial direction) H1 of the opening 70a of the outer clearance 72 is set to be 0.3 mm or larger and 0.7 mm or smaller (0.3 mm≤H≤0.7 mm). As shown in FIG. 4, the outer clearance 72 is formed by an annular small space. The outer clearance 72 has a shape continuing in a straight line in the flow passage direction. Thus, the clearance dimension (in the axial direction) of the outer clearance 72 is constant along the radial direction and equal to the dimension H1 of the opening 70a. A. length (in the radial direction) L1 of the outer clearance 72 in the flow passage direction is the distance from the opening 70a to an outer circumferential surface of the seal fixing part 54 (the cylindrical covering part 81a). The length L1 is equal to the sum of a thickness dimension (in the radial direction) t of the second axial part 68 of the slinger 52 and a clearance dimension (in the radial direction) H2 of the central clearance 71 (L1=t+H2).

The clearance dimension (in the radial direction) 112 of the central clearance 71 is set to be 0.3 mm or larger and 1.0 mm or smaller (0.3 mm≤H2≤1.0 mm). As shown in FIG. 4, the central clearance 71 is formed by a cylindrical small clearance, The central clearance 71 has a shape continuing in a straight line in the flow passage direction. Thus, the clearance dimension H2 of the central clearance 71 is constant along the axial direction. It is preferable that a length (in the axial direction) L2 of the central clearance 71 in the flow passage direction be set to be long. Therefore, the length L2 of the central clearance 71 in the flow passage direction is 3 mm or longer (L2≥3 mm). An upper limit value (as a guide) of the length L2 of the central clearance 71 is, for example, 7 mm (L2≤7 mm). This value is based on restrictions on the dimensions of the sealing device 46. The length L2 of the central clearance 71 is the distance from an end (end surface) of the second axial part 68 on the other side in the axial direction to a surface of the seal fixing part 54 (the cylindrical covering part 81a) on the one side in the axial direction.

A clearance dimension (in the axial direction) H3 of the inner clearance 73 is equal to the clearance dimension H2 of the central clearance 71. Thus, the clearance dimension H3 of the inner clearance 73 is set to be 0.3 mm or larger and 1.0 mm or smaller (0.3 mm≤H3≤1.0 mm). As show in FIG. 4, the inner clearance 73 is formed by an annular small space. Since the inner clearance 73 has a shape continuing in a straight line in the flow passage direction, the clearance dimension H3 of the inner clearance 73 is constant along the radial direction and equal to the dimension of the opening 70b. It is preferable that a length L3 of the inner clearance 73 in the flow passage direction be set to be long. Therefore, the length (in the radial direction) L3 of the inner clearance 73 in the flow passage direction is 2.5 mm or longer (L3≥2.5 mm). An upper limit value (as a guide) of the length L3 of the inner clearance 73 is, for example, 4.0 mm (L3≤4.0 mm) This value is based on restrictions on the dimensions of the sealing device 46.

The length L3 of the inner clearance 73 is the distance from the outer circumferential surface of the seal fixing part 54 to a coupling portion 69 between the second radial part 66 and the first axial part 64 of the slinger 52. The coupling portion 69 has a rounded shape. Therefore, the length L3 is the distance from the outer circumferential surface of the seal fixing part 54 to a rounding start point 66s that is a point in the round coupling portion 69 on the side of the second radial part 66. The position of the rounding start point 66s coincides with the position of the opening 70b.

As has been described above, in the sealing device 46 of this disclosure, the labyrinth clearance 70 includes the outer clearance 72 opening outward, the central clearance 71 which is continuous with the outer clearance 72 and of which the flow passage direction intersects with that of the outer clearance 72, and the inner clearance 73 which is continuous with the central clearance 71 and of which the flow passage direction intersects with that of the central clearance 71. The dimension H1 of the opening 70a of the outer clearance 72 is 0.3 mm or larger and 0.7 mm or smaller. The central clearance 71 is set to be as long as possible to secure the length thereof in the flow passage direction, and the length L2 of the central clearance 71 in the flow passage direction is 3 mm or longer. The clearance dimension H3 of the inner clearance 73 is 0.3 mm or larger and 1.0 mm or smaller,

In the sealing device 46 having the labyrinth clearance 70 with the dimensions thus set, the labyrinth clearance 70 makes it less likely that external water enters inside the sealing device 46. The function of restricting entry of water by the labyrinth clearance 70 is enhanced in a state where the inner shaft member 14 is rotating relatively to the outer ring member 12, i.e., a state where the vehicle is traveling. On the other hand, when the vehicle stops and the inner shaft member 14 stops rotating and, moreover, the vehicle is in an environment where at least part of the sealing device 46 in the circumferential direction is under water, water may pass through the labyrinth clearance 70 and enter inside the sealing device 46 under the influence of a water pressure from the outside. It is when the road is flooded that at least part of the sealing device 46 in the circumferential direction is under water. An assumed depth of water when the road is flooded is, for example, a value equal to the level of the centerline C (see FIG. 1) of the bearing device 10 (the value of the radius of the wheel).

When the vehicle resumes traveling and the inner shaft member 14 rotates, water having entered inside the sealing device 46 is delivered toward the outside by a centrifugal force. The water is difficult to discharge due to the influence of the water pressure from the outside. However, a water film is formed in the outer clearance 72, the central clearance 71, and the inner clearance 73 of the labyrinth clearance 70 owing to the dimensions (the dimension H1, the length L2, and the dimension H3) of these parts set as described above, and this water film can exert a force against the water pressure from the outside. When the inner shaft member 14 rotates with a water film formed in the labyrinth clearance 70, a centrifugal force acts also on water inside the labyrinth clearance 70, particularly water inside the outer clearance 72 and the inner clearance 73 having the flow passages extending in the radial direction, which helps discharge the water inside to the outside. Since the water film formed in the labyrinth clearance 70 thus exerts a force against the water pressure from the outside, securing the function of this water film can enhance the water discharge efficiency of the sealing device 46. For this reason, the sealing device 46 of this disclosure can restrain water from entering inside and easily discharge water having entered inside to the outside.

When a water film is formed in the outer clearance 72, the central clearance 71, and the inner clearance 73 of the labyrinth clearance 70 owing to the settings of the dimensions (the dimension H1, the length L2, and the dimension L3) of these parts as described above, this water film functions like a lid. Entry of external water is more effectively restricted by the water film.

The clearance dimension H2 of the central clearance 71 is set to be 0.3 mm or larger and 1.0 mm or smaller. This configuration can enhance the function of restricting entry of external water and serves to maintain a water film formed in the central clearance 71. The inner clearance 73 is set to be as long as possible to secure the length thereof in the flow passage direction, and the length L3 of the inner clearance 73 in the flow passage direction is 2.5 mm or longer. This configuration can further enhance the function of restricting entry of external water and serves to maintain a water film formed in the central clearance 71.

As described above, the dimension H1 of the opening 70a of the outer clearance 72 is set to be 0.3 mm or larger and 0.7 mm or smaller. If the dimension H1 of the opening 70a is set to a value within this range, external water is less likely to enter due to surface tension of water in the opening 70a. It is especially preferable that the dimension H1 be 0.6 mm or smaller. In this case, the opening of the outer clearance 72 has a dimension of 0.6 mm or smaller.

If the dimension H1 of the opening 70a is set to be 0.3 mm or larger and 0.7 mm or smaller, a water film formed in the outer clearance 72 will have a meniscus with an appropriate shape in the opening 70a and this water film is maintained. Thus, the dimension H1 of the opening 70a is set to a value suitable for retaining a water film in the outer clearance 72, and further retaining a water film in the central clearance 71.

If the dimension H1 is smaller than 0.3 mm, the function of preventing entry of water into the sealing device 46 is enhanced but the efficiency of discharging water having entered inside decreases. If the dimension H1 exceeds 0.7 mm, the function of preventing entry of water may degrade. The outer clearance 72 functions to retain a water film in the central clearance 71 by water inside the outer clearance 72 (the flow passage resistance of the outer clearance 72). If the dimension H1 of the opening 70a exceeds 0.7 mm, the outer clearance 72 cannot be expected to create a flow passage resistance to water and may hardly function to retain a water film in the central clearance 71.

As described above, the length L2 of the central clearance 71 in the flow passage direction is set to be 3 mm or longer. If the length L2 is shorter than 3 mm, the central clearance 71 is too short to function to prevent entry of water. Moreover, if the length L2 is shorter than 3 mm, an effective water film haying a force to withstand a water pressure from the outside is less likely to be formed in the central clearance 71. Thus, the central clearance 71 cannot be expected to create a flow passage resistance to water and may hardly function to retain a water film.

As described above, the clearance dimension H3 of the inner clearance 73 is set to be 0.3 mm or larger and 1.0 mm or smaller. If the clearance dimension H3 is smaller than 0.3 mm, the function of preventing entry of water into the sealing device 46 is enhanced but the efficiency of discharging water that has entered inside decreases. The clearance dimension H3 of the inner clearance 73 is set to a value suitable for retaining a water film in the inner clearance 73, and further retaining a water film in the central clearance 71.

If the clearance dimension H3 of the inner clearance 73 exceeds 1.0 mm, the function of preventing entry of water may degrade. The inner clearance 73 functions to retain a water film in the central clearance 71 by water inside the inner clearance 73 (the flow passage resistance of the inner clearance 73). If the clearance dimension H3 of the inner clearance 73 exceeds 1.0 mm, the inner clearance 73 cannot be expected to create a flow passage resistance to water and may hardly function to retain a water film in the central clearance 71.

One thing that the outer clearance 72 and the inner clearance 73 have in common is that both function to retain (i.e., keep) water (a water film) in the central clearance 71. However, the upper limit value (0.7 mm) of the clearance dimension H1 of the outer clearance 72 and the upper limit value (1.0 mm) of the clearance dimension H3 of the inner clearance 73 are different from each other for the following reasons. The outer clearance 72 is shorter in the flow passage direction. The inner clearance 73 is longer than the outer clearance 72 in the flow passage direction. Thus, a first reason is that the inner clearance 73 creates a larger flow passage resistance than the outer clearance 72. A second reason is that the outer clearance 72 opens outward while the inner clearance 73 is a clearance located on a deeper side of the labyrinth clearance 70 (far away from the opening 70a).

The above-described dimensions of the parts of the labyrinth clearance 70 are values that the inventor of the present disclosure has obtained by conducting numerous experiments and simulations.

Sealing Device 46 of this Disclosure

As has been described above, the sealing device 46 of this disclosure includes the seal member 50 and the slinger 52. As shown in FIG. 3, the seal member 50 has, on the outer circumferential side, the large-diameter part 53 that has a larger outside diameter than the seal fixing part 54. The large-diameter part 53 faces, in the axial direction, the end 68a of the second axial part 68 of the slinger 52 on the other side in the axial direction across the outer clearance (second clearance) 72. The central clearance (first clearance) 71 and the outer clearance (second clearance) 72 communicate with each other, and the sealing device 46 has the labyrinth clearance 70 including the central clearance 71 and the outer clearance 72. As described above, the outer circumferential surface 53f of the large-diameter part 53 and the outer circumferential surface 68f of the second axial part 68 are included in the flow passage surface 74a of the continuous outside flow passage 74 extending in a straight line along the axial direction.

In the sealing device 46 having this configuration, the labyrinth clearance 70 makes it less likely that external water enters inside the sealing device 46 where the seal lip 58 is present. As described above, the large-diameter part 53 has a larger outside diameter than the seal fixing part 54 and faces, in the axial direction, the end 68a of the second axial part 68 of the slinger 52 on the other side in the axial direction across the outer clearance 72. Thus, as the large-diameter part 53 functions as a barrier, water flowing toward the one side in the axial direction along the outer circumferential surface 12f of the outer ring member 12 (arrow F1) is less likely to enter inside the sealing device 46. Since the outer clearance 72 opens toward the radially outer side, even when a large volume of water flows and part of the water flows over the large-diameter part 53 toward the one side in the axial direction, this water is less likely to enter through the opening 70a of the outer clearance 72 and passes by the opening 70a.

The outer circumferential surface 53f of the large-diameter part 53 and the outer circumferential surface 68f of the second axial part 68 are included in the flow passage surface 74a of the continuous outside flow passage 74 extending in a straight line along the axial direction. Therefore, even when a large volume of water flows and part of the water flows over the large-diameter part 53 toward the one side in the axial direction (arrow F2), this water can pass by the opening 70a of the outer clearance 72, without stagnating near the opening 70a, and flow along the outer circumferential surface 68f of the second axial part 68. Thus, the water is less likely to enter through the opening 70a of the outer clearance 72. For these reasons, the sealing device 46 of this disclosure has an enhanced function of preventing external water from entering the space between the outer ring member 12 and the inner shaft member 14.

When the travel speed of the vehicle is low (e.g., 10 km per hour) and a large volume of water (e.g., five liters per minute) flows, the external water may enter inside the sealing device 46. However, the sealing device 46 having the configuration shown in FIG. 3 can restrict entry of water even when the travel speed of the vehicle is low and a large volume of water flows around the outer ring member 12.

As shown in FIG. 2, at least a portion of the first radial part 62 of the slinger 52 has the contact surface 76 that is in contact with the annular wall surface 14g of the inner shaft member 14. The inner shaft member 14 further has the stepped surface 14h extending from the end 14g-1 of the annular wall surface 14g on the radially outer side toward the one side in the axial direction. The outer circumferential surface 64f of the first axial part 64 of the slinger 52 and the stepped surface 14h of the inner shaft member 14 constitute the bottom surface 78a of the common gutter structure 78.

Thus, the gutter structure 78 is constituted by a part of the slinger 52 and a part of the inner shaft member 14. The bottom surface 78a of the gutter structure 78 is constituted by the outer circumferential surface 64f of the first axial part 64 of the slinger 52 and the stepped surface 1411 of the inner shaft member 14. If a large volume of water flows toward the one side in the axial direction along the outer circumferential surface 12f of the outer ring member 12 and part of the water flows over the large-diameter part 53 toward the one side in the axial direction (arrow F2), and further flows along the outer circumferential surface 68f of the second axial part 68 (arrow F3), this water is caught by the gutter structure 78.

Other than the outer circumferential surface 64f of the first axial part 64 of the slinger 52, the stepped surface 14h of the inner shaft member 14 is also included in the bottom surface 78a of the gutter structure 78, which adds to the volume of the gutter structure 78. Thus, the gutter structure 78 can catch a large volume of water. Since water is caught by the gutter structure 78, water can be restrained from flowing toward the outer clearance 72 by changing its flow direction to a direction toward the other side in the axial direction. As a result, even when the volume of water is large, the water is allowed to fall down onto the road surface by the gutter structure 78, so that the water can be prevented from returning to the opening 70a of the labyrinth clearance 70 and entry of water is thus prevented.

As has been described above, the sealing device 46 of this disclosure has an enhanced function of preventing external water from entering the space between the outer ring member 12 and the inner shaft member 14. Moreover, the sealing device 46 is configured such that water that has entered inside the sealing device 46, if any, is easily discharged to the outside.

Others

in the bearing device 10 of this disclosure, the inner shaft member 14 rotates around the bearing centerline C relatively to the outer ring member 12. The sealing device 46 of this disclosure can also be applied to rolling bearing devices other than the rolling bearing device (hub unit) 10 for a wheel, as long as the rolling bearing device to which the sealing device 46 is applied has an outer member (outer ring member 12) and an inner member (inner shaft member 14) that rotate around the bearing centerline C relatively to each other. Thus, while this is not shown, depending on the application of the rolling bearing device, the outer member may rotate around the bearing centerline relatively to the inner member.

Various changes can be made to the forms of the outer ring member (outer member) 12 and the inner shaft member (inner member) 14. Changes can be made to the forms of the seal member 50 and the slinger 52 within the scope of the present disclosure, and forms other than those shown in the drawings may also be adopted.

The embodiment disclosed this time is in every respect merely illustrative and not restrictive. The technical scope of the present disclosure is not limited to the above embodiment, and this technical scope includes all changes within a scope equivalent to that of the configuration described in the claims.

What is claimed is:

1. A sealing device comprising:
an annular seal member mounted on an outer member; and
an annular slinger mounted on an inner member that rotates relatively to the outer member, wherein:
a labyrinth clearance is provided in a part of a clearance between the annular seal member and the annular slinger;
the labyrinth clearance includes an outer clearance that opens toward an outside, a central clearance which is continuous with the outer clearance and of which a flow passage direction intersects with a flow passage direction of the outer clearance, and an inner clearance which is continuous with the central clearance and of which a flow passage direction intersects with the flow passage direction of the central clearance;
an opening of the outer clearance has a dimension of 0.3 mm or larger and 0.7 mm or smaller;
the central clearance has a length of 3 mm or longer in the flow passage direction; and
the inner clearance has a clearance dimension of 0.3 mm or larger and 1.0 mm or smaller.

2. The sealing device according to claim 1, wherein the central clearance has a clearance dimension of 0.3 mm or larger and 1.0 mm or smaller.

3. The sealing device according to claim 1, wherein the inner clearance has a length of 2.5 mm or longer in the flow passage direction.

4. A rolling bearing device comprising:
an outer member;
an inner member;
a plurality of rolling elements provided between the outer member and the inner member; and
a sealing device that prevents foreign objects from entering a bearing inner space which is between the outer member and the inner member and in which the rolling elements are provided, wherein
the sealing device is the sealing device according to claim 1.
